(19) United States
(12) Patent Application Publication
(10) Pub. No.: US 2025/0281785 A1
(43) Pub. Date: Sep. 11, 2025

(54) AUTOMATIC AUXILIARY DRAIN FOR A FIRE CONTROL SYSTEM

(71) Applicant: Potter Electric Signal Company, LLC, Maryland Heights, MO (US)

(72) Inventors: Dave FRIEDRICH, Ellisville, MO (US); Jason WEBB, Urich, MO (US)

(21) Appl. No.: 19/073,781

(22) Filed: Mar. 7, 2025

Related U.S. Application Data
(60) Provisional application No. 63/562,591, filed on Mar. 7, 2024.

(51) Int. Cl. A62C 35/68; F16K 24/04

(52) U.S. Cl. CPC A62C 35/68; F16K 24/044

(57) ABSTRACT

An automated auxiliary drain valve for a sprinkler system which works both to automate collection and release of condensate through the auxiliary drain, and can provide an automatic shutoff in the event that the auxiliary drain reservoir is damaged. The automated functioning of the automatic drain is also stopped should the sprinkler system be activated elsewhere.

### CROSS-REFERENCE TO RELATED APPLICATION(S)

This application claims benefit of U.S. Provisional Patent Application No. 63/562,591, filed on Mar. 7, 2024, the entire disclosure of which is herein incorporated by reference.

### BACKGROUND OF THE INVENTION

### Field of the Invention

The present invention generally relates to auxiliary drain systems for use in automatic fire control systems, Specifically to an automated auxiliary drain and anti-flood valve.

### Description of the Related Art

To fight fires in modern buildings, firefighters use a wide variety of tools but are also regularly aided by systems within the building. Modern buildings almost universally include liquid-based fire sprinkler protection systems to control or extinguish fires. Fire sprinkler systems generally follow a fairly standardized principle. A liquid firefighting material (generally water) is distributed to the area of the fire by a series of interconnected pipes, generally held under pressure, which are arranged throughout all areas of the building.

In a wet pipe system, the liquid firefighting material is actually stored within the pipes, whereas in a dry pipe system, the liquid is stored external to the piping often with the system simply being connected to a pressurized municipal water source by a valve while the pipes contain pressurized air, nitrogen, or other gas that serves to keep the valve closed. The gas is maintained under pressure and the pressure of the gas (so long as it remains higher than the water) keeps a valve closed to inhibit the attached liquid from entering the pipes. Should the gas pressure in the pipes drop, the valve opens and the pressurized water enters the system.

Attached to these pipes are various sprinkler heads which, when activated, provide a point of egress from the pipes. When a wet pipe system is activated, the liquid will spray from the pipes out the egress into a predetermined area. In a dry pipe system, the system first allows gas to escape at the sprinkler head. The escape of gas reduces the gas pressure in the piping system and that allows the pressure valve held shut by the gas to open and liquid to enter the system, which liquid (as it is also under pressure) naturally will travel to the same open sprinkler head and be sprayed in the target area. These systems are robust and simple and have proven themselves effective over many years of use

Virtually all sprinkler systems, both wet and dry pipe systems, are vulnerable to leaks and to corrosion due to the presence of water and oxygen in the piping. Originally in wet pipe systems, systems were attached and fill methods were used that attempted to remove oxygen from inside the pipe as water in the pipe was unavoidable. The goal was to completely fill the pipe with water and push out any oxygen to inhibit corrosion. However, the more modern technology of dry pipe systems attempt to eliminate water from the system to inhibit corrosion. In the most modern dry pipe systems, inert gases such as nitrogen are used in place of oxygen containing gases (usually air) to attempt to eliminate both water and oxygen from the system.

While sprinkler systems have gotten increasingly good at eliminating water and/or oxygen from the inside of the pipes, they aren't perfect and some oxygen and water will invariably find its way into the pipes. Often, these are due to the need to flush and test the systems (often using water) or to fill them quickly to get them back to operating pressures (which often requires the use of environmental air, which also often includes evaporated moisture as well). Further, all types of sprinkler systems need to be able to drain water after they have been activated and need to be brought back into service.

The vast majority of draining operations (either after use or testing) occurs using the main drain of the sprinkler system. This is typically a large drain attached to the main in the sprinkler system which allows for the entire piping arrangement of the sprinkler system to be drained. Typically, the main drain will drain outside of the structure that the sprinkler system is in due to the amount of water that will pass through it when the system is draining. However, the main drain is not the only drain. A piping system will often include auxiliary drains which are designed to deal with irregularities in the layout of the piping.

In particular, the piping systems will typically be laid out so that gravity will cause liquid in the piping to flow to the main drain and facilitate draining. While this is the goal, it will often not be accomplished due to practical realities. Typically, at least some portion of the piping layout simply does not lend itself to draining from all areas to the main drain, may simply have not been built in a way that the liquid flow is accomplished as intended, or due to settling, age, or damage, the liquid may not flow toward the main drain anymore from certain sections.

To deal with the these situations, the sprinkler system will typically include a plurality of auxiliary drains. These are much smaller drains that are designed to drain a section of piping where water does not drain to the main drain as intended. These, therefor, act to drain a small portion of the piping on their own. Auxiliary drains typically will not only be used to drain the system when the main drain is used but may also be used when the system is not being fully drained. Auxiliary drains are often designed to slowly trap condensate or other liquid build up in the piping over time and allow for regular draining of this trapped material without the need to drain the entire sprinkler system. This can inhibit freezing of the piping system and to help eliminate liquid and associated corrosion.

Because the positioning of auxiliary drains is often dictated by the arrangement of the piping, auxiliary drains are often located inside the structure using the sprinkler system. Often they are in areas such as janitor's closets or parking garages where they are out of the way, can easily drain to a bucket, a built in water drain, or even onto a floor (such as the concrete floor of a parking garage). Further, to allow the removal of condensate over time, auxiliary drains are typically constructed to allow for periodic drainage even when the main drain is not being used to drain the entire system and without taking the system out of use. As such, auxiliary drains have traditionally been built to allow for water release without substantial pressure loss from the system as a whole.

An auxiliary drain will generally comprise a generally vertical pipe through which water from within the piping system will slowly flow over time. The end of the pipe will then typically include two spaced valves with a portion of pipe or a reservoir or tank between them. One valve will be at the lowest end of the pipe and the other is often arranged a foot or two above it with the reservoir between them. The reservoir between the two valves is often a wider section of pipe which can act as a collector. In normal operation of the sprinkler system, the lowest valve will be closed while the upper valve is open. Thus, should water enter the vertical pipe, it will flow down through the upper valve and collect in the reservoir above the lower valve. To remove condensate without inadvertently triggering the system, the upper valve is closed to maintain system pressure, and then the lower valve is opened. This allows the water to drain out without any substantial pressure loss to the system as a whole. The lower valve is then closed again and the upper valve reopened to return the system back to operation. As the reservoir is a relatively small volume compared to the sprinkler piping as a whole, the slight loss of pressure from this operation is typically insufficient to trigger sprinkler system activation and is readily made up by standard leak compensation technologies installed elsewhere in the sprinkler system.

While this traditional auxiliary valve functions just fine, its simplicity creates certain difficulties. In the first instance, it is a very manual system requiring a workman to go and drain out the reservoir over time. If this is not done, water can buildup in the reservoir which can result in freezing and damage to the reservoir. Because the system is positioned more inside the structure and often more accessible, it is also often more subject to damage. In particular, auxiliary drains are often in parking areas and if an auxiliary drain is hit by a car, it can easily break. Because the closed valve in normal operation is at the very bottom, any damage above the valve that will result in an egress from the piping can mimic a fire situation and trigger the system to begin filling and spraying water from the auxiliary drain area.

Even if fairly quickly shut off from the upper valve, in a dry system the addition of water to the system from such damage can take substantial time to recover from. Further, if the system breaks above the upper valve it can be devastating as there is no easy way to shut off the opening and the water source will typically have to be shut-off to the entire sprinkler system while the auxiliary drain is repaired. Even if the drain can be shut-off because the upper valve is intact, one must know to do it. This often requires a workman who knows how the system works to get to it and close the valve. As high pressure water may often be coming out, this is sometimes easier said than done.

Breakage of the auxiliary valve due to impact or such direct damage is rare, but not unheard off. Often a bigger problem with an auxiliary drain is that the auxiliary drain is in an area (such as a parking area) where it is more exposed to weather and environmental conditions. Cold temperatures, snow, and other similar conditions can cause the pipes to freeze and cause associated breakage in the reservoir. This is often not detected until the temperatures warm, and thawing causes the reservoir to leak and potentially mimic a sprinkler opening situation triggering water to flood a dry system.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein is an automated auxiliary drain valve for a sprinkler system which works both to automate collection and release of condensate through the auxiliary drain, and can provide an automatic shutoff in the event that the auxiliary drain reservoir is damaged. The automated functioning of the automatic drain is also stopped should the sprinkler system be activated elsewhere.

Described herein, among other things, is an auxiliary drain system for a fire sprinkler system, the drain system comprising: a drain housing including an input port for obtaining water from a fire sprinkler system; a float within said drain housing, said float alternatively sealing and unsealing an exhaust port in said housing; and a temperature sensitive spring attached to said float, said temperature sensitive spring providing a first biasing force on said float at a first temperature and a second biasing force on said flat at a second temperature; wherein said first biasing force is greater than said second biasing force; wherein said first temperature is higher than said second temperature; and wherein water within said drain housing will act on said float and against said temperature sensitive spring to unseal said exhaust port.

In an embodiment, the drain system further comprises a spring having a third biasing force less than said first biasing force and greater than said second biasing force.

In an embodiment of the drain system, a first predetermined volume of water in said housing will unseal said exhaust port at said first temperature.

In an embodiment of the drain system, a second predetermined volume of water, less than said first predetermined volume of water, will unseal said exhaust port at said second temperature.

In an embodiment, the drain system further comprises an anti-flood valve, said anti flood valve comprising: a valve housing; a valve mechanism within said housing, said valve mechanism comprising: a generally cylindrical plunger including an internal channel, said internal channel generally shaped as a conical frustum with a generally cylindrical component at the top thereof extended through an upper surface of said plunger; a valve peg having a generally cylindrical portion with a diameter smaller than a diameter of said upper surface of said plunger with a generally conical frustum portion thereon; a biasing spring holding said plunger in an upper position with an outer surface of said frustum portion of said valve peg spaced from an inner surface of said internal channel

In an embodiment of the drain system, said anti-flood valve is connected to said fire sprinkler system upstream of said drain housing.

In an embodiment of the drain system, said anti-flood valve is connected to said drain housing via a breakaway connector.

In an embodiment of the drain system, water on said upper surface will flow through said internal channel and over said frustum portion of said valve peg.

In an embodiment of the drain system, said valve peg includes a through channel in said cylindrical portion and a window through a side wall of said cylindrical portion for accessing said through channel; wherein water flowing over said frustum portion of said valve peg flows through said window, into said through channel, and into said input port of said drain housing.

In an embodiment of the drain system, said upper surface of said plunger is generally planar.

In an embodiment of the drain system, said valve peg includes an O-ring on the outer surface thereof.

In an embodiment of the drain system, an amount of water above a predetermined volume on said upper surface will overcome said holding of said biasing spring and depress said internal channel into contact with at least a part of said valve peg.

In an embodiment of the drain system, said contact closes said internal channel.

There is also described herein, in an embodiment, an auxiliary drain system for a fire sprinkler system, the drain system comprising: an anti-flood valve comprising: a valve housing; a valve mechanism within said housing, said valve mechanism comprising: a generally cylindrical plunger including an internal channel, said internal channel generally shaped as a conical frustum with a generally cylindrical component at the top thereof extended through an upper surface of said plunger; a valve peg having a generally cylindrical portion with a diameter smaller than a diameter of said upper surface of said plunger with a generally conical frustum portion thereon; a biasing spring holding said plunger in an upper position with an outer surface of said frustum portion of said valve peg spaced from an inner surface of said internal channel; a drain housing including an input port for obtaining water from a fire sprinkler system; a float within said drain housing, said float alternatively sealing and unsealing an exhaust port in said housing.

In an embodiment of the drain system, said anti-flood valve is connected to said fire sprinkler system upstream of said drain housing.

In an embodiment of the drain system, said anti-flood valve is connected to said drain housing via a breakaway connector.

In an embodiment of the drain system, water on said upper surface will flow through said internal channel and over said frustum portion of said valve peg.

In an embodiment of the drain system, said valve peg includes a through channel in said cylindrical portion and a window through a side wall of said cylindrical portion for accessing said through channel; wherein water flowing over said frustum portion of said valve peg flows through said window, into said through channel, and into said input port of said drain housing.

In an embodiment of the drain system, an amount of water above a predetermined volume on said upper surface will overcome said holding of said biasing spring and depress said internal channel into contact with at least a part of said valve peg.

In an embodiment of the drain system, said contact closes said internal channel.

### BRIEF DESCRIPTION OF THE DRAWINGS

FIG. 1 Provides a front drawing of an auxiliary drain system for a fire control system including a first embodiment of an automatic drain.

FIG. 2 Provides a drawing of the embodiment of FIG. 1 in place on a fire control system pipe.

FIG. 3 provides a perspective drawing of an auxiliary drain system for a fire control system including a second embodiment of an automatic drain for a fire control system.

FIG. 4 provides a front drawing of the embodiment of FIG. 3.

FIG. 5 provides a cutaway drawing of the embodiment of FIG. 3.

FIG. 6 provides a cutaway drawing of an embodiment of an automatic drain for a fire control system that resists freezing damage.

FIG. 7 provides a cutaway drawing of the flood control valve of FIG. 3 in its open position.

FIG. 8 provides a cutaway drawing of the flood control valve of FIG. 3 in a partially closed position.

FIG. 9 provides a cutaway drawing of the flood control valve of FIG. 3 in its closed position.

### DETAILED DESCRIPTION OF THE PREFERRED EMBODIMENT(S)

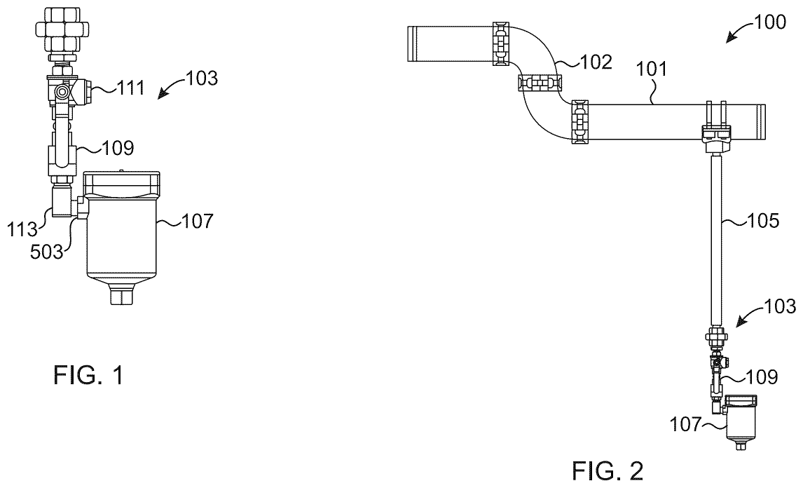

FIG. 1 provides a first view of an embodiment of an automated auxiliary drain (103). The drain (103) is positioned in a sprinkler system (100) in FIG. 2. FIG. 2 shows a portion (100) of a sprinkler system the type known to those in the art. It will typically be a dry pipe system (but may be a wet system in some embodiments) and may utilize any form of gas (specifically either nitrogen or air) to fill the system (100). Attached to an arm (101) of the sprinkler system (101) (which will typically be a portion not easy to drain to the main drain (as illustrated by the elbow (102))), is an auxiliary drain system (103). The auxiliary drain system (103) is connected to the arm (101) by a connector (105) which comprises a vertical pipe in fluid communication with the interior of the arm (101). The arm (101) will typically be arranged and the connector (105) will be attached so that it is at or near a low point of the arm (101). Thus, fluid will typically flow from the arm (101) into the connector (105) and into the auxiliary drain system (103).

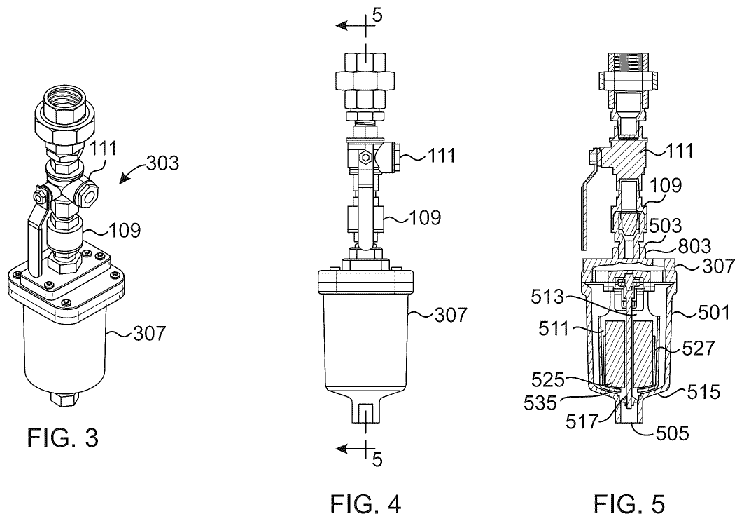

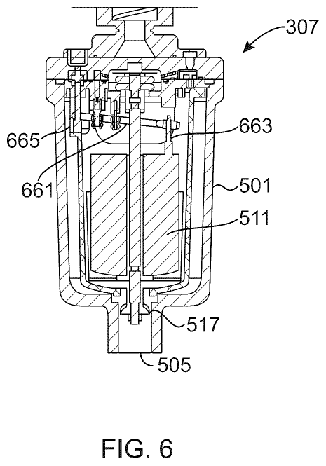

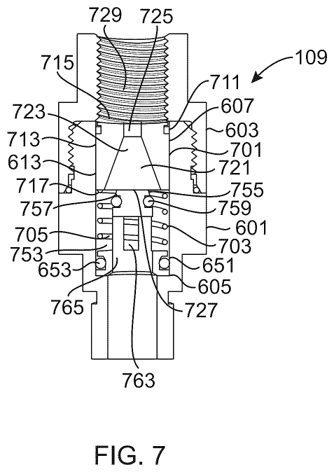

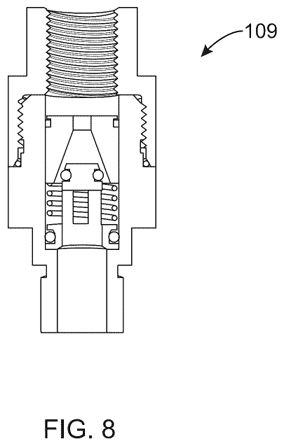

The auxiliary drain system (103) generally comprises two major components: an automatic drain (107) and a flood control or anti-flood valve (109) which are typically attached to each other and together form the auxiliary drain system (103). The auxiliary drain system (103) is connected to the connector (105) at its terminal end via a manual valve (111). The manual valve (111) can be used to shut down fluid flow into the auxiliary drain system (103) completely when needed. This may be, for example, for service or replacement. FIGS. 3-5 provide a more detailed view of a second embodiment of the drain (303), FIG. 6 provides a view of an automatic drain that resists freezing damage, and FIGS. 7-9 will be used to provide a discussion of the operation of an embodiment of an anti-flood valve (109).

Comparing the embodiment of FIG. 4 to the embodiment of FIG. 1, it should be apparent that the two embodiments of the auxiliary drain system (103) and (303) are generally similar. The only difference is that the drain (307) in the embodiment of FIG. 4 connects to the anti-flood valve (109) with the anti-flood valve (109) directly above the automatic drain (307) while the anti-flood valve (109) is off to the side of the automatic drain (107) in the embodiment of FIG. 1. This is simply two different arrangements of the components and both are generally acceptable. The second embodiment (FIG. 4) will generally be preferred, however, as it eliminates the bend (113) where water could collect and not flow into the drain (103). Because the automatic drains (107) and (307) are otherwise similar, the discussion in conjunction with the drain (307) of FIG. 5 could also be applied to the drain (107) of FIG. 1, and vice-versa, simply moving the input port (503) to the alternative location depicted in FIG. 1.

An embodiment of the drain (307) as best shown in FIG. 5 generally includes a main housing (501) comprising a storage vessel suitable for holding liquid and particularly water. The main housing (501) includes an input port (503) at the top and an exhaust port (505) at the bottom. The lower surface (515) of the housing (501) will typically be slanted toward the exhaust port (505), generally forming the shape of a funnel, to help direct fluid within the housing (501) into the exhaust port (505). The exhaust port (501) is closed by a seal (517). The seal (517) is movable upward and downward and is attached to a float (511) which is inside the housing (501). The float (511) in the depicted embodiment is positioned on a vertical shaft (513) which is mounted toward the top to the housing (501) and in the embodiment of FIG. 5 directly below the input port (503).

The drain (307) of FIG. 5 is essentially a float valve. Pressurized gas from the piping arm (101) is allowed to flow into the housing (501) via the input port (503). As the interior volume of the housing (501) is in fluid communication with the piping (101), the housing (501) will typically be at the same pressure as the piping (101) which will typically be above the ambient pressure outside the exhaust port (505). This increased pressure will provide a force to hold the seal (517) into the exhaust port (505). However the primary closure mechanism of the seal (505) may also simply be the mass of the float (501) being pulled toward the exhaust port (505) by gravity. In the embodiment of FIG. 6, this force is supplemented by the biasing force of a spring system.

Should water flow into the housing (501), it will generally flow over the float (511) and travel beside and around it. The funnel shape of the lower surface (515) will typically direct the water toward a base (525) of the float (511) and water will collect at a space (535) of the housing (501) around where the seal (517) is closing the exhaust port (505). It should be recognized that unless the system (100) is being actively filled and drained, water flow into the connector (105) will generally be minimal and the flow would be more like a trickle or even drops at a time.

As water accumulates at the bottom (535) of the housing (501), the water will tend to be pushed toward the exhaust port (505) and the base (525) of the float (511) by the angled base (515) of the housing (501) accumulating in the space (535). The water, in some respects, is even pushed between the exhaust port (505) and the seal (517) of the float (511) and the water will typically want to flow under the float (511). However, the seal (517) is effectively in the way inhibiting the water from moving further downward and into the exhaust port (505).

As the amount of water in the housing (501) increases, the float (511) will typically be slowly forced upward from the water accumulating underneath the float (511) and the water pushing on the bottom (525) of the float (511) trying to raise it. The water under the float (511) will slowly increase which serves to lift the float (511) and the attached seal (517). At some point and some predetermined volume of water, the water level under the float (511) will be sufficient to overcome the weight of the float (511) and the float (511) will lift vertically along the shaft (513) “floating” on the surface of the water. This vertical movement will also move the seal (517) out of the exhaust port (505).

As soon as the seal (517) moves, water can flow out the exhaust port (505). However, as the water flows out the exhaust port (505), the amount of water under the float (511) and in the space (535) will decrease. If the housing (501) is sufficiently full, this may result in water from between the sides (517) of the float (511) and the housing (501) to flow under the float (511) and maintain buoyancy. However, so long as the seal (517) remains raised, water will leave the system from the exhaust port (505).

Eventually, the amount of water in space (535) will be insufficient to keep the float (511) raised. Once this happens, the float (511) will move downward on the shaft (513) and the seal (517) will reenter the exhaust port (505) sealing it and stopping the flow of water. The above process will then repeat with water again building up around the float (511) until the volume of water is again sufficient to cause the float (511) to lift.

In this way the float (511) and seal (517) combination serves to automatically allow for water to drain from the housing (501). Whenever the water level is sufficiently high, the seal (517) will open and some water will drain out until it is no longer high enough to support the float (511). It should be recognized that the process of opening and closing need not operate on a margin where the seal (517) is opening and closing as the water level fluctuates around a single value. Instead, inherent friction in the system, and the system design itself, may produce an arrangement where the water level will generally have to rise above a first predetermined level for the seal (517) to be removed and the float (511) will not return the seal (517) to the exhaust port (505) until the level of water is reduced to a second, and typically lower, water level. In an embodiment, the drain (307) will often be expected to open and drain when about 9 ounces of water has collected. Upon the exhaust port (505) opening, around 4-5 ounces of water will typically be released before the seal (517) will reseat resulting in around 4-5 ounces of water remaining in the housing (501) after a drain event.

It should also be recognized that while the drain (307) is less susceptible to freezing damage than the traditional reservoir, it is not immune. The drain (307) will typically have less issue with freezing damage because the amount of water in the housing (501) will typically have a constrained maximum (as anything above that maximum will cause the seal (517) to open and water to leave) and the housing may be sized and shaped so that even if that amount of water is present and freezes, the housing (501) includes sufficient space for the ice to occupy without damaging the housing (501). Still further, the float (511) system can still operate even if some ice is present, allowing water to continue to escape even if the system is in the process of freezing or thawing.

An alternative embodiment, shown in FIG. 6, provides for an alternative arrangement of a drain (307) which provides further protection from damage from freezing. As in the embodiment of FIG. 5, the drain (307) includes a float (511) and seal (517). In standard operation, the embodiment of FIG. 6 will operate in the same fashion as the embodiment of FIG. 5. However, the embodiment of FIG. 6 provides for additional protection against freezing. One concern with the presence of water in the drain (307) occurs at the point of freezing. Because water is an anomalous liquid, it will expand when it freezes. This can result in the water present in the drain (307) at the freezing point causing damage due to the expansion. Specifically, the freezing water could damage the seal (517) or could even damage the housing (501) if there is a sufficient amount. As discussed above, the drain (307) in an embodiment will typically have between 4 ounces and 9 ounces of water in it at any time. This may be more than is desired and could result in freezing damage, particularly if the amount is near the upper end of the range.

To avoid this damage, the embodiment of FIG. 6 utilizes a system which allows the drain (307) to drain water more easily as the temperature drops. Specifically, the seal (517) is partially held in place by a lever (661) which acts to push the float (511) downward. The lever (661) is, in turn, supported by two springs (663) and (665). The first of these is a normal spring (665). The second is a temperature sensitive spring (663). The temperature sensitive spring (663) is constructed so that it's spring coefficient changes based on temperature and may be constructed of a material capable of martensitic transformation such as, but not limited to, a nickel titanium alloy (e.g. nitinol). Thus, the temperature sensitive spring (663) will provide a reduced biasing force at colder temperatures than at warmer temperatures. The two springs (663) and (665) are typically arranged so as to bias the lever (661) in opposing directions. Based on their relative biasing force, the lever (661) will either be pushed downward if the biasing force of the temperature sensitive spring (663) is greater, will be neutral if the two biasing forces are equal, or will be pulled upward if the normal spring (665) has the greater biasing force.

In operation, the normal spring (665) will have a reduced biasing force compared to the temperature sensitive spring (663). There will generally not be a large amount of difference between the two, but this difference will serve to assist in keeping the seal (517) closed by forcing the float downward slightly. However, because the difference is not that great, should the water level rise to sufficient level such as the 9 ounces discussed above in conjunction with FIG. 5, the float (511) can still rise upward countering the difference in biasing force of the temperature sensitive spring (663) above the normal spring (665) to release liquid out the exhaust port (505). However, as contemplated in conjunction with FIG. 5, the float (511) will not rise and unseal the seal (517) because of any water being collected, it will only do so once a sufficient level of water has collected to justify the opening in normal operation and upon closing 4-5 ounces may still remain.

However, as the temperature gets colder, any amount of water trapped in the housing (501) awaiting discharge can become increasingly problematic and the amount that needs to be present to open the seal (517) normally may be too much to be safe. To deal with this, the temperature sensitive spring (663) will typically have its spring coefficient decrease as the temperature approaches the freezing point of water. This decrease serves to reduce the difference in the spring coefficient for the temperature sensitive spring (663) and the normal spring (665) eventually making the biasing force of the normal spring greater. This transition makes it easier for the float (511) to rise and the seal (517) to open the exhaust port (505) as the normal spring (665) is now assisting in the float (511) opening the seal (517).

Typically, the specific composition, arrangement, and structure of the temperature sensitive spring (663) will be such that when the freezing point of water is reached (or just before), the temperature sensitive spring (663) will effectively fail to provide a biasing force above the normal spring (665), or even at all. Based on the spring coefficient of the normal spring (665) and the weight and related characteristics of the float valve (511), it can be the case that virtually any amount of water could serve to lift the float (511) and open the exhaust port discharging the water. In this way, there will typically be little to no water in the drain (307) at the time that the water would be exposed to freezing temperatures.

As an example, using the embodiment of FIG. 5, if the seal (517) will normally move at 9 ounces of water present and reseal at 4 ounces of water, the spring arrangement of FIG. 6 at or near freezing temperature can result in 4 ounces of water still being sufficient to open the seal (517) and it only closing when a smaller amount of water remains. While illustrative, these numbers are purely hypothetical and other ranges can be used. It should be recognized that water expands by around 9% during freezing, so if the housing is capable of holding 9 ounces of liquid water, it will often be able to hold 8 ounces or less of ice without major damage. Thus, in an embodiment, the springs (663) and (665) may be selected to as to simply allow a maximum water collection of less than 8 ounces at or around freezing temperature. One concern, however, is that additional water may enter the housing (501) after water in the housing (501) has frozen and that water may only freeze once in the housing (501). For this reason, the amount of water allowed to remain in the housing (501) when the housing (501) is below freezing temperature may be much less than contemplated above.

It should be recognized that the seal (517) will generally not open the exhaust port (505) with no water present regardless of temperature as the exhaust port (505) being open could result in gas pressure loss in the piping (101). However, a smaller amount of water typically will not be sufficient to cause any damage as even with freezing-based expansion, there is sufficient available space that the ice created cannot damage any of the structures and will just exist in the housing (501).

As the temperature increases from below freezing, the process discussed above of spring biasing alteration will typically reverse. Specifically, the temperature sensitive spring (663) will have its spring coefficient increase. This will serve to push the float (511) downward and better engage seal (517) with the exhaust port (505). This, in turn, will mean that more water is required to be held in the housing (501) before the float can lift to exhaust the water.

In both the embodiments of FIGS. 5 and 6, the process of draining the auxiliary drain (307) is automated in a consistent and repeatable fashion. No individual needs to come and open the valve to drain the system (100). Further, because gas in the system (100) will generally not be allowed to escape because the float (511) will lower before all the water has been evacuated (the water flow inhibiting gas flow by filling all available volume), the automatic drain (307) will generally have little to no effect on the total pressure in the sprinkler system (100).

While the drain (307) serves to automate the evacuation of remaining water as well as water from condensate, it should recognize that the drain (307) does present a potential risk to the system (100) in the event of system activation. Specifically, should the system (100) activate elsewhere, the gas pressure inside the piping, and thus in the housing (501) will be reduced and water will flow into the piping and thus connector (105). That water may very well flow into the drain (307) which can cause the float (511) to float and cause the exhaust port (505) to open. Should this happen, water which needs to be flowing toward the open sprinkler and toward the fire, could actually be flowing out the exhaust port (505) which can render the firefighting properties of the system less effective.

Because of the automated nature of the drain (307), there will typically be a desire to inhibit any damage to the drain (307) from triggering the system (100) because the drain (307) will typically not be observed as regularly as a manual drain may have to be. In an embodiment, water levels, temperature, ice formation, and/or any operational or other characteristics of the drain may be remotely monitored to check for potential damage. This will typically be providing a relevant sensor to the drain (307) which can provide information to a remote monitoring control such as, but not limited to, a fire control panel or a mobile device (such as a smartphone or tablet). In addition or alternative to the above, the drain (307) may connected to the connector (105) via an anti-flood valve (109).

The anti-flood valve (109) is intended to inhibit flow out the drain (307) in the event of system activation, in the event that the drain (307) is badly damaged, or even if the drain (307) is removed. In effect, if the exhaust port (505) is held in a state of fully open because the drain (307) is stuck open or if water and/or gas can leave the housing for some other reason (e.g. because the housing is damaged), the anti-flood valve (109) will typically serve to close off gas and water access to the drain (307). The anti-flood valve (109) also serves to close the drain (307) and stop automatic draining in the event of system (100) activation.

Damage to the drain (307) presents a unique concern as the drain (307) internally includes the valves of shutting off water flow. Further, the anti-flood valve (109) can only work to inhibit water flow from the connector (105) so long as it is present and undamaged. To encourage damage to occur downstream of the anti-flood valve (109), there may be provided a break-away point or connector (803) at our around the input port (503) of the drain (307). As contemplated best in FIGS. 3-5, there may also be included a manual valve (111) to seal off both elements of the automatic drain (103) from the connector (105) to facilitate service, replacement, or in the event of catastrophic damage to the anti-flood valve (109). In an embodiment, the manual valve (111) may comprise a ball valve and a strainer which may be integrated with the ball valve or separate. The strainer can assist in keeping the automatic drain (307) and anti-flood valve (109) clean.

FIGS. 6-8 provide for cut through drawings of an embodiment of an anti-flood valve (109) as shown in FIGS. 1-5 in three different positional states. The anti-flood valve (109) depicted therein comprises a two part (601) and (603) housing which serves to enclose the valve mechanism (607). The upper housing (603) is designed to attach to the connector (105) while the lower housing (601) will connect to the automatic drain (307). The valve mechanism (607) comprises a plunger (701) which is held in an upper position as shown in FIG. 7 by a biasing spring (605) which in the depicted embodiment is a standard coil spring but other designs may be used in alternative embodiments. The biasing spring (605) rests on a sealing element (605) which includes a channel (651) with an O-ring (653) therein. The sealing element (605) may also serve to hold a valve peg (705) in place

The plunger (701) is generally cylindrical and may include an O-ring (711) or similar component to inhibit water from passing between the outer surface (713) of the plunger (701) and the inner surface (613) of the lower housing (601). The plunger (701) includes an upper surface (715) with significantly greater solid surface area than its lower surface (717). The plunger (701) also includes an internal channel (721). The channel (721), in the depicted embodiment, is in the shape of a conical frustum (723) with a cylindrical channel component (725) connected to the top thereof. The channel (721), thus, provides a fluid passage through the plunger (701) which has a smaller intake (729) than exhaust (727). The intake (729) is also typically a relatively small area compared to the area of the upper surface (715).

The plunger (701) is arranged above and generally centered over the valve peg (705). The valve peg (705) includes a generally cylindrical portion (765) that has a smaller diameter than the diameter of the plunger (701) so as to have its outer surface (753) spaced from the inner surface (613) of the lower housing (601). This is typically through the use of the sealing element (605) as indicated above. The diameter of the of the valve peg (705) will also typically be larger than the internal diameter of the cylindrical component (725) of the channel (721) but smaller than the largest (base) internal diameter of the conical frustum component (723) of the channel (721). This allows for the peg to enter the channel (721) through the lower surface (717) of the plunger (701) but to not pass all the way through the channel (721).

The top of the valve peg (705) will typically terminate in a cone or conical frustum portion (755). Toward or at the base of the conical frustum portion (755), there is a channel (757) with an O-ring (759) therein. The outer diameter of the O-ring (759) will typically be larger than the diameter of the conical frustum portion (755) so as to extend beyond the expected structure of the conical frustum portion (755) as depicted. Both portions (755) and (765) of the valve peg (705) will typically be hollow and open on both ends and may include windows (763) or other openings through the outer surface of either or both the cylindrical portion (765) or conical frustum portion (755).

The shape of the plunger (701) and valve peg (705) will serve to act as the opening and closing mechanism of the anti-flood valve (109). When positioned on the terminal end of the connector (105), water will flow into the upper housing (603) and will land on the upper surface (715) of the plunger (701). The water will typically flow toward the opening (729) but the upper surface (715) may not be, and typically won't be, specifically angled to encourage this. Instead, the upper surface (715) will generally be substantially planar. Should the water flow into the cylindrical portion (725) of the channel (721), the water will generally be encouraged by the shape of the channel (721) to fall toward the center of the channel (721) and may enter the hollow interior of the valve peg (705) from the top where it will pass through the valve peg (705) and out the bottom of the lower housing (601). In the embodiment of FIGS. 3-5, this water will then pass into the drain valve (307). In an embodiment, water may also or alternatively flow over the frustum portion (755) to enter the windows (763) and the hollow interior of the valve peg (705).

Should surface tension result in the water sticking to the sides of the frustum component (723) of the channel (721), the water will typically drop into the lower housing (601) outside the valve peg (705). This water will typically be positioned on the sealing element (605). From there, it can easily flow through the windows (763) which also gets it inside the follow interior of the valve peg (705) and directs it out the bottom of the lower housing (601).

In default, this results in the anti-flood valve (109) remaining in the open position of FIG. 7 as small amounts of water are insufficient to counteract the biasing force of spring (603) and the water simply flows through the plunger (701), over the valve peg, and out the anti-flood valve (109) in normal operation. However, should the amount of water flowing out of the connector (105) increase, the limited size of the cylindrical portion (725) of the channel (721) compared to the upper surface (715) of the plunger (701) will typically act as a bottleneck and water will begin to accumulate on the upper surface (715) as it cannot escape sufficiently quickly.

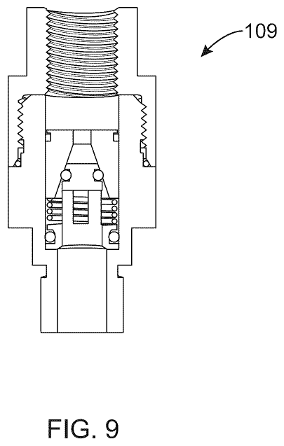

Should the amount of water above the upper surface (715) increase enough because it cannot escape through the channel (721) as fast as it is arriving, the mass of the water, and potentially the pressure of it in the connector (105), can become sufficient to begin to counteract the force of the biasing spring (603). Thus, if the flow is relatively low, the water will present insufficient force on the upper surface (715) to overcome the biasing of the spring (603), and the water will slowly flow through the channel (721), into the valve peg (705), and out of the anti-flood valve (109). Should a greater percentage of water, or water under substantially more pressure be presented, the pressure presented by the water on the upper surface (715) will be greater and the plunger (701) will begin to move downward. This is shown in FIG. 8.

Should the pressure on the upper surface (715) be sufficient, such as if water is freely filling the connector (105) as would be the case should the system be activated, the water pressure on the upper surface (715) will fully depress the plunger (701) against the biasing mechanism (603) to the position shown in FIG. 9. This will cause the interior surface of the frustum component (723) of the channel (721) to engage the outer surface of the frustum portion (755) of the peg (705) and the O-ring (759). This engagement will serve to seal the channel (721) and inhibit water from flowing into the peg (705) and out the flood valve. As water cannot escape at all at this stage, the plunger (701) will generally be unable to move from the position of FIG. 9 as the water which overcame the biasing force of the spring (603) has no way to escape and will remain on the upper surface (715) indefinitely. Thus, the valve (109) is held shut and will typically require an intervention to re-open.

As should be apparent, if the system (101) is activated, or if damage occurs to the automatic drain (107) sufficient to create water flow into the connector (105), the anti-flood valve (109) will close and be held closed as contemplated in conjunction with FIG. 9 above due to the volume of water flowing toward the drain (307). Thus, should the sprinkler system (101) activate, the anti-flood valve (109), once closed, will typically stay closed until it is removed and reset. Thus, the system (101) will operate in much the same way as if the automatic drain (107) was not present or the manual valve (111) was closed.

The combination of the automatic drain (107) in conjunction with the anti-flood valve (109) provides for an essentially fully automated auxiliary drain system (103). The drain system (103), thus, provides for automatic draining of water typically without loss of significant gas pressure allowing the system (107) to operate autonomously and insure that draining is done correctly. Further, because the draining is automatic, the likelihood of freezing due to water buildup in the automatic drain (107) or other problem from lack of attention is generally reduced or eliminated. However, the inclusion of the anti-flood valve (109) then backs up the automatic drain (107) allowing the system (103) to deal with activation or damage also in an automated fashion.

By fully automating routine operation of an auxiliary drain and automating drain shutoff in the event of a damage or system activation, the auxiliary drain (103) can be removed from maintenance requirements dramatically simplifying maintenance workloads. Further, the automatic auxiliary drain (103) can then be monitored using sensors or other devices and its operation can be reported remotely. For example, the system (103) may monitor how often the float valve (511) opens which will give an indication of the amount of water discharged. This can then be reported to maintenance personnel so that the system can be monitored for water incursion or other leaks.

While the invention has been disclosed in conjunction with a description of certain embodiments, including those that are currently believed to be useful embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “cylindrical” are purely geometric constructs and no real-world component or relationship is truly “cylindrical” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

1. An auxiliary drain system for a fire sprinkler system, the drain system comprising:
a drain housing including an input port for obtaining water from a fire sprinkler system;
a float within said drain housing, said float alternatively sealing and unsealing an exhaust port in said housing; and
a temperature sensitive spring attached to said float, said temperature sensitive spring providing a first biasing force on said float at a first temperature and a second biasing force on said flat at a second temperature;
wherein said first biasing force is greater than said second biasing force;
wherein said first temperature is higher than said second temperature; and
wherein water within said drain housing will act on said float and against said temperature sensitive spring to unseal said exhaust port.

2. The drain system of claim 1 further comprising a spring having a third biasing force less than said first biasing force and greater than said second biasing force.

3. The drain system of claim 1 wherein a first predetermined volume of water in said housing will unseal said exhaust port at said first temperature.

4. The drain system of claim 1 wherein a second predetermined volume of water, less than said first predetermined volume of water, will unseal said exhaust port at said second temperature.

5. The drain system of claim 1 further comprising an anti-flood valve, said anti flood valve comprising:
a valve housing;
a valve mechanism within said housing, said valve mechanism comprising:
a generally cylindrical plunger including an internal channel, said internal channel generally shaped as a conical frustum with a generally cylindrical component at the top thereof extended through an upper surface of said plunger;
a valve peg having a generally cylindrical portion with a diameter smaller than a diameter of said upper surface of said plunger with a generally conical frustum portion thereon;
a biasing spring holding said plunger in an upper position with an outer surface of said frustum portion of said valve peg spaced from an inner surface of said internal channel.

6. The drain system of claim 5 wherein said anti-flood valve is connected to said fire sprinkler system upstream of said drain housing.

7. The drain system of claim 6 wherein said anti-flood valve is connected to said drain housing via a breakaway connector.

8. The drain system of claim 5 wherein water on said upper surface will flow through said internal channel and over said frustum portion of said valve peg.

9. The drain system of claim 5 wherein said valve peg includes a through channel in said cylindrical portion and a window through a side wall of said cylindrical portion for accessing said through channel; wherein water flowing over said frustum portion of said valve peg flows through said window, into said through channel, and into said input port of said drain housing.

10. The drain system of claim 5 wherein said upper surface of said plunger is generally planar.

11. The drain system of claim 5 wherein said valve peg includes an O-ring on the outer surface thereof.

12. The drain system of claim 5 wherein an amount of water above a predetermined volume on said upper surface will overcome said holding of said biasing spring and depress said internal channel into contact with at least a part of said valve peg.

13. The drain system of claim 12 wherein said contact closes said internal channel.

14. An auxiliary drain system for a fire sprinkler system, the drain system comprising:
an anti-flood valve comprising:
a valve housing;
a valve mechanism within said housing, said valve mechanism comprising:
a generally cylindrical plunger including an internal channel, said internal channel generally shaped as a conical frustum with a generally cylindrical component at the top thereof extended through an upper surface of said plunger;
a valve peg having a generally cylindrical portion with a diameter smaller than a diameter of said upper surface of said plunger with a generally conical frustum portion thereon;
a biasing spring holding said plunger in an upper position with an outer surface of said frustum portion of said valve peg spaced from an inner surface of said internal channel;
a drain housing including an input port for obtaining water from a fire sprinkler system;
a float within said drain housing, said float alternatively sealing and unsealing an exhaust port in said housing.

15. The drain system of claim 14 wherein said anti-flood valve is connected to said fire sprinkler system upstream of said drain housing.

16. The drain system of claim 15 wherein said anti-flood valve is connected to said drain housing via a breakaway connector.

17. The drain system of claim 14 wherein water on said upper surface will flow through said internal channel and over said frustum portion of said valve peg.

18. The drain system of claim 14 wherein said valve peg includes a through channel in said cylindrical portion and a window through a side wall of said cylindrical portion for accessing said through channel; wherein water flowing over said frustum portion of said valve peg flows through said window, into said through channel, and into said input port of said drain housing.

19. The drain system of claim 14 wherein an amount of water above a predetermined volume on said upper surface will overcome said holding of said biasing spring and depress said internal channel into contact with at least a part of said valve peg.

20. The drain system of claim 19 wherein said contact closes said internal channel.
